(19) United States
(12) Patent Application Publication
(10) Pub. No.: US 2004/0072944 A1
(43) Pub. Date: Apr. 15, 2004

(54) Reactive formulations comprising anitmicrobial polymers

(76) Inventors: Peter Ottersbach, Windeck (DE); Friedrich Sosna, Dorsten (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/466,710

(22) PCT Filed: Dec. 13, 2001
(86) PCT No.: PCT/EP01/14683

(30) Foreign Application Priority Data
Jan. 23, 2001 (DE) 101029004

(51) Int. Cl. C08L 33/06

(52) U.S. Cl. 524/562; 524/560; 524/565

(57) ABSTRACT

The invention relates to the use of antimicrobial polymers in reactive formulations and to the use of said reactive formulations.

The invention relates to the addition of antimicrobial polymers to reactive formulations and to their use in these formulations.

It is highly undesirable for bacteria to be established or spread on the surfaces of pipelines, or of containers or packaging. Slime layers frequently form and permit sharp rises in microbial populations, and these can lead to persistent impairment of the quality of water or of drinks or of foods, and even to spoilage of the product and harm to the health of consumers.

Bacteria must be kept away from all fields of life where hygiene is important. This affects textiles for direct body contact, especially in the genital area, and those used for care of the elderly or sick. Bacteria must also be kept away from the surfaces of the furniture and instruments used in patient-care areas, especially in areas for intensive care or neonatal care, and in hospitals, especially in areas where medical intervention takes place, and also in isolation wards for critical cases of infection, and in toilets.

A current method of treating equipment, or the surfaces of furniture or of textiles, to resist bacteria, either when this becomes necessary or else as a precautionary measure, is to use chemicals or solutions of these, or else mixtures, these being disinfectant and having fairly broad general antimicrobial action. Chemical agents of this type act nonspecifically and are themselves frequently toxic or irritant, or form degradation products which are hazardous to health. In addition, people frequently exhibit intolerance to these materials once they have become sensitized.

Another procedure to counteract surface spread of bacteria is the incorporation of antimicrobial substances into a matrix.

Another challenge of constantly increasing significance is the avoidance of algal growth on surfaces, since there are now many external surfaces on buildings with plastic cladding, which is particularly susceptible to colonization by algae. As well as giving an undesirable appearance, this can in some circumstances also impair the functioning of the components concerned. One relevant example is colonization by algae of surfaces with a photovoltaic function.

Another form of microbial contamination for which again no technically satisfactory solution has been found is fungal infestation of surfaces. For example, Aspergillus niger infestation of joints or walls in wet areas not only impairs appearance but also has serious health implications, since many people are allergic to the substances given off by the fungi, and the results can even be serious, chronic, respiratory disease.

In the marine sector, the fouling of boats' hulls affects costs, since the growth of fouling organisms is attended by an increase in the boat's flow resistance, and thus by a marked increase in fuel consumption. Problems of this type have hitherto generally been countered by incorporating toxic heavy metals or other low-molecular-weight biocides into antifouling coatings with the aim of mitigating the problems described. To this end, the damaging side effects of coatings of this type are accepted, but as society's environmental awareness rises this state of affairs is increasingly problematic.

U.S. Pat. No. 4 532 269, for example, therefore discloses a terpolymer made from butyl methacrylate, tributyltin methacrylate and tert-butylaminoethyl methacrylate. This copolymer is used as an antimicrobial paint for ships, and the hydrophilic tert-butylaminoethyl methacrylate promotes slow erosion of the polymer, thus releasing highly toxic tributyltin methacrylate as active antimicrobial agent.

In these applications, the copolymer prepared using amino methacrylates is merely a matrix or carrier for added microbicidal active ingredients which can diffuse or migrate out of the carrier material. At some stage polymers of this type lose their activity once the necessary minimum inhibitor concentration (MIC) at the surface has been lost.

It is also known from European patent applications 0 862 858 that copolymers of tert-butylaminoethyl methacrylate, a methacrylate having a secondary amino function, has inherent microbicidal properties.

This terpolymer exhibits what is known as contact-microbicidal properties, without addition of any microbicidal active ingredient. Many contact-microbicidal polymers are disclosed in the following patent applications: DE 100 24270, DE 10022 406, PCT/EP00/06501, DE 10014 726, DE 100 08 177, PCT/EP00/06812, PCT/EP00/06487, PCT/EP00/06506, PCT/EP00/02813, PCT/EP00/02819, PCT/EP00/02818, PCT/EP00/02780, PCT/EP00/02781, PCT/EP00/02783, PCT/EP00/02782, PCT/EP00/02799, PCT/EP00/02798, PCT/EP00/00545, PCT/EP00/00544.

No low-molecular-weight constituents are present in these polymers; the antimicrobial properties are attributable to contact of bacteria with the surface.

Processing methods for combining materials are in principle any of the methods of plastics processing, e.g. the preparation of a compound by combining the materials, processing by means of coextrusion, or else introduction into systems for (surface) coating. In these processes, the antimicrobial homo- or copolymers are either prepared and used as they stand or are used with other polymers as described in the form of a polymer blend.

For effective avoidance of undesirable resistance phenomena in microbes, particularly bearing in mind that the development of resistance to microbes is known from antibiotic research, systems developed in the future will again have to be based on novel compositions with improved effectiveness. Alongside this, an equally important part is played by application-related issues, because the antimicrobial polymers are often processed together with other plastics in order to increase the resistance of these to microbiological attack, or ideally to inertize them entirely. The known systems are still unsatisfactory in terms of stability and ease of use.

An elegant route to novel antimicrobial polymer systems would consist in preparing the antimicrobial polymers and then bonding these in a particularly durable manner to other plastics.

Surprisingly, it has been found that a surface can be provided with sufficient antimicrobial action by adding a defined amount of antimicrobial polymer to a reactive mixture of monomers, where appropriate with polymerization initiators and other additives. It has proven advantageous here for the antimicrobial polymer, rather than the monomer(s) used to prepare the antimicrobial polymer, to be added to the reactive mixture, since this procedure can achieve effective antimicrobial action.

The present invention therefore provides antimicrobial reactive formulations comprising one or more polymerizable monomers and one or more antimicrobial polymers.

The polymerizable monomers may be olefinically unsaturated monomers capable of free-radical polymerization, or else polycondensible monomers. Examples of these monomers are given below.

The reactive formulations may themselves comprise appropriate initiators, such as thermal initiators or UV initiators; it is also possible to treat a previously prepared mixture with these initiators prior to use of the formulation.

It is preferable to use nitrogen- and phosphorus-functionalized monomers to prepare the antimicrobial polymers, and in particular the antimicrobial polymers are prepared from at least one of the following monomers: 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and/or 3-aminopropyl vinyl ether.

The proportion of the antimicrobial polymers in the reactive formulations may be from 0.01 to 25% by weight, preferably from 0.01 to 10, particularly preferably from 0.1 to 5%, by weight.

The design of the process of the invention is such that antimicrobial polymers are added in polymeric form to the reactive mixture, which alongside any admixed initiators and additives, e.g. light stabilizers and heat stabilizers, is preferably composed of olefinically unsaturated monomers, e.g. of vinyl derivatives, of styrene compounds, of allyl derivatives, of olefins, of compounds of acrylic or methacrylic acid, in particular here methyl methacrylate, methyl acrylate, tert-butyl methacrylate, tert-butyl acrylate, butyl methacrylate, butyl acrylate, ethyl methacrylate, ethyl acrylate, propyl methacrylate, isopropyl methacrylate, propyl methacrylate, propyl acrylate, isopropyl acrylate, or very generally of units which form macromolecules, which in the case of the polycondensible monomers also include combinations of lactams, of diols, of isocyanates, of diisocyanates, of epoxides, of diacids, or of epoxy-resin-forming compounds.

This reaction mixture is then induced to react in accordance with the respective curing process on which the reactive mixture is based, e.g. via introduction of heat, of light, or of moisture. The result of this is a cured semifinished product or resin, with antimicrobial properties. This antimicrobial products can then either be used directly, e.g. in polymethyl methacrylate sheets cured in a mold, or else may be prepared for further treatment steps via subsequent physical treatment, e.g. milling.

Examples of uses of the resultant products are use as an aqueous solution or directly in powder form, e.g. for sterilizing cooling-water circuits, or indirect use, e.g. via addition to paints or other surface coatings.

The formulations are preferably used in the form of powders or polymer particles, but may also be used in dissolved form, e.g. together with a suitable solvent. The grain sizes of the polymer particles are preferably below 1 mm, particularly preferably below 500 μm.

These coatings may comprise, besides the compounds of the invention, any polymer, preferably polyamides, polyurethanes, polyether block amides, polyesteramides, polyesterimides, PVC, polyolefins, silicones, polysiloxanes, polymethacrylate, and/or polyterephthalates, or may be applied to these polymers.

Use of the Reactive Formulations

The present invention also provides the use of the reactive formulations of the invention for producing antimicrobial products, and the resultant products themselves. These products are preferably based on polyamides, on polyurethanes, on polyether block amides, on polyesteramides, on polyesterimides, on PVC, on polyolefins, on silicones, on polysiloxanes, on polymethacrylate, or on polyterephthalates, on metals, on glass, on wood, or on ceramics, which have surfaces coated with compounds of the invention or with polymer formulations of the invention.

By way of example, antimicrobial products of this type are in particular machinery parts for the processing of food or of drinks, components of air-conditioning systems, coated pipes, semifinished products, roofing, bathroom items, toilet items, kitchen items, components of sanitary equipment, components of animal cages and of animal houses, recreational products for children, components of water systems, packaging for food or drinks, operator units (touch panels) of devices, and contact lenses.

These formulations may be used wherever it is important that surfaces have maximum freedom from bacteria, algae, and fungi, i.e. are microbicidal, or that surfaces have release properties. Examples of use of the compounds of the invention or polymer formulations of the invention are found in the following sectors:

marine: boat hulls, docks, buoys, drilling platforms, ballast water tanks

construction: roofing, basements, walls, facades, greenhouses, sun protection, garden fencing, wood protection

sanitary: public conveniences, bathrooms, shower curtains, toilet items, swimming pools, saunas, jointing, sealing compounds

requisites for daily life: machines, kitchen, kitchen items, sponge pads, recreational products for children, packaging for food or drinks, milk processing, drinking-water systems, cosmetics

machinery products: air-conditioning systems, ion exchangers, process water, solar-powered units, heat exchangers, bioreactors, membranes, cooling water treatment

medical technology: contact lenses, diapers, membranes, implants

consumer articles: automobile seats, clothing (socks, sports clothing), hospital equipment, door handles, telephone handsets, public conveyances, animal cages, cash registers, carpeting, wallpapers

The present invention also provides the use of items in medical technology or hygiene products produced using formulations prepared according to the invention. The above descriptions of preferred materials are again applicable. Examples of these hygiene products are toothbrushes, toilet seats, combs, and packaging materials. The term hygiene item also includes other articles which can sometimes come into contact with large numbers of people, examples being telephone handsets, stair rails, door handles, window catches, and also grab straps and grab handles in public conveyances. Examples of items in medical technology are catheters, tubing, protective or backing films, and also surgical instruments.

The reactive formulations of the invention are also used as a biofouling inhibitor, in particular in cooling circuits. To prevent damage to cooling circuits by infestation with algae or bacteria, the circuits have to be cleaned frequently or appropriately oversized. In the open cooling systems usually found in power plants and in chemical plants, the addition of microbicidal substances, such as formalin, is not possible.

Other microbicidal substances are frequently highly corrosive or form foams, preventing their use in systems of this type.

In contrast, the reactive formulations of the invention in the form of undiluted material or blend, or in the form of a coating on other polymers in finely dispersed form, can be fed into the process water. The bacteria are killed on contact with the antimicrobial compounds or with the polymer formulations and, if necessary, are removed from the system by filtering off the dispersed polymer/blend from the system. Deposition of bacteria or algae on components of the system can thus be effectively inhibited.

The present invention therefore also provides a process for sterilizing cooling-water streams, by adding antimicrobial reactive formulations in dispersed form or antimicrobial compounds in dispersed form to the cooling water.

Reactive formulation hereinafter always means the fully polymerized form of the antimicrobial polymer in the formulations of the invention.

The dispersed form of the reactive formulations may be obtained in the preparation process itself, e.g. by emulsion polymerization, precipitation polymerization, or suspension polymerization, or subsequently by milling of the antimicrobial polymer, e.g. in a jet mill. Preference is given to the use of the resultant particles with a size distribution of from 0.001 to 3 mm (spherical diameter), so that firstly a large surface area is available to kill the bacteria or algae and secondly separation from the cooling water, e.g. by filtration, is readily possible where required. An example of a method of conducting the process consists in removing continuously a portion (5 to 10%) of the reactive formulations used from the system and replacing this with a corresponding amount of fresh material. As an alternative, further antimicrobial reactive formulation may be added as required, while checking the number of microbes in the water. Depending on the quality of the water it is sufficient to add from 0.1 to 100 g of antimicrobial reactive formulation per m³ of cooling water.

The examples below are given for further description of the present invention, and provide further illustration of the invention but are not intended to restrict its scope as set out in the claims.

### EXAMPLE 1

50 mL of dimethylaminopropylmethacrylamide (Aldrich) and 250 mL of ethanol are charged to a three-necked flask and are heated to 65° C. under a stream of argon. 0.5 g of azobisisobutyronitrile dissolved in 20 mL of ethanol is then slowly added dropwise, with stirring. The mixture is heated to 700 and stirred at this temperature for 6 hours. After this time has expired, the solvent is removed from the reaction mixture by distillation, and this is followed by drying in vacuo at 50° C. for 24 hours. The product is then dissolved in 200 ml of acetone, and then the solvent is removed from the reaction mixture by distillation, and this is followed by drying in vacuo at 50° C. for 24 hours. The reaction product is then finely ground in a mortar.

### EXAMPLE 1a

50 mL of methyl methacrylate (Aldrich), 0.25 g of azobisisobutyronitrile (Aldrich), and 2 g of the product from Example 1 are mixed and placed in a polyethylene bag, which is sealed and has been secured between two metal plates positioned at a separation of 3 cm, parallel to one another. This structure is then dipped for a period of 14 hours into a 60° C. waterbath. After the time has expired, the structure is removed from the waterbath, and the cured plastics slab is separated from the polyethylene film after cooling to room temperature.

### EXAMPLE 1b

A piece of the plastics slab from Example 1 a with dimensions 3×3 cm is secured on the base of a glass beaker in which there are 10 mL of a test microbe suspension of Pseudomonas aeruginosa. The system thus prepared is then shaken for a period of 4 hours. 1 mL of the test microbe suspension is then removed. After this time has expired, the number of microbes has fallen from 10⁷ to 10³ microbes per mL.

### EXAMPLE 2

50 mL of tert-butylaminoethyl methacrylate (Aldrich) and 250 mL of ethanol are charged to a three-necked flask and are heated to 65° C. under a stream of argon. 0.5 g of azobisisobutyronitrile dissolved in 20 mL of ethanol is then slowly added dropwise, with stirring. The mixture is heated to 70° C. and stirred at this temperature for 6 hours. After this time has expired, the solvent is removed from the reaction mixture by distillation, and this is followed by drying in vacuo at 50° C. for 24 hours. The product is then dissolved in 200 ml of acetone, and then the solvent is removed from the reaction mixture by distillation, and this is followed by drying in vacuo at 50° C. for 24 hours.

### EXAMPLE 2a

50 mL of methyl methacrylate (Aldrich), 0.25 g of azobisisobutyronitrile (Aldrich), and 2 g of the product from Example 2 are mixed and placed in a polyethylene bag, which is sealed and has been secured between two metal plates positioned at a separation of 3 cm, parallel to one another. This structure is then dipped for a period of 14 hours into a 6020 C. waterbath. After the time has expired, the structure is removed from the waterbath, and the cured plastics slab is separated from the polyethylene film after cooling to room temperature.

### EXAMPLE 2b

A piece of the plastics slab from Example 2 a with dimensions 3×3 cm is secured on the base of a glass beaker in which there are 10 mL of a test microbe suspension of Pseudomonas aeruginosa. The system thus prepared is then shaken for a period of 4 hours. 1 mL of the test microbe suspension is then removed. After this time has expired, the number of microbes has fallen from 10⁷ to 10² microbes per mL.

### EXAMPLE 2c

50 mL of isopropyl methacrylate (Aldrich), 0.25 g of azobisisobutyronitrile (Aldrich), and 2 g of the product from Example 2 are mixed and placed in a polyethylene bag, which is sealed and has been secured between two metal plates positioned at a separation of 3 cm, parallel to one another. This structure is then dipped for a period of 14 hours into a 6020 C. waterbath. After the time has expired, the structure is removed from the waterbath, and the cured plastics slab is separated from the polyethylene film after cooling to room temperature.

### EXAMPLE 2d

A piece of the plastics slab from Example 2 c with dimensions 3×3cm is secured on the base of a glass beaker in which there are 10 mL of a test microbe suspension of Pseudomonas aeruginosa. The system thus prepared is then shaken for a period of 4 hours. 1 mL of the test microbe suspension is then removed. After this time has expired, the number of microbes has fallen from 10⁷ to 10² microbes per mL.

### EXAMPLE 2e

50 mL of butyl methacrylate (Aldrich), 0.25 g of azobisisobutyronitrile (Aldrich), and 3 g of the product from Example 2 are mixed and placed in a polyethylene bag, which is sealed and has been secured between two metal plates positioned at a separation of 3 cm, parallel to one another. This structure is then dipped for a period of 14 hours into a 60° C. waterbath. After the time has expired, the structure is removed from the waterbath, and the cured plastics slab is separated from the polyethylene film after cooling to room temperature.

### EXAMPLE 2f

A piece of the plastics slab from Example 2 e with dimensions 3×3cm is secured on the base of a glass beaker in which there are 10 mL of a test microbe suspension of Pseudomonas aeruginosa. The system thus prepared is then shaken for a period of 4 hours. 1 mL of the test microbe suspension is then removed. After this time has expired, the number of microbes has fallen from 10⁷ to 10² microbes per mL.

### EXAMPLE 2g

50 mL of methyl acrylate (Aldrich), 0.25 g of azobisisobutyronitrile (Aldrich), and 2 g of the product from Example 2 are mixed and placed in a polyethylene bag, which is sealed and has been secured between two metal plates positioned at a separation of 3 cm, parallel to one another. This structure is then dipped for a period of 14 hours into a 6020 C. waterbath. After the time has expired, the structure is removed from the waterbath, and the cured plastics slab is separated from the polyethylene film after cooling to room temperature.

### EXAMPLE 2h

The product from Example 2 g is comminuted in a centrifugal mill and separated by means of a screening machine into fractions of various grain sizes. 0.1 g of the fraction with grain sizes smaller than 80 micrometers is added to 20 ml of a test microbe suspension of Pseudomonas aeruginosa. The system thus prepared is then shaken for a period of 4 hours. 1 mL of the test microbe suspension is then removed. After this time has expired, no remaining Pseudomonas aeruginosa microbes are detectable.

### EXAMPLE 2i

16 g of adipic acid (Aldrich), 42 g of oleic acid (Aldrich), 44 g of phthalic anhydride (Aldrich), 105 g of anhydrous 1,1,1-trihydroxymethylpropane (Aldrich), and 2 g of the product from Example 2 are weighed into a 500 ml three-necked flask with stirrer and downward-inclined condenser with vacuum adapter, and the air is expelled by evacuation and chilling with argon. The mixture is then slowly heated under a low-velocity stream of argon until at about 124° C. the contents of the flask begin to melt, whereupon stirring can be started. The internal temperature is now brought to 175° C. within 2.5 hours. As soon as the temperature at the head of the column falls below 70° C., a pump is connected and the system is slowly evacuated to 30 torr over the course of 2 hours. The mixture is stirred for a further 7 hours at this pressure and at an internal temperature of 175° C. The pump is then switched off and the mixture is allowed to cool under argon. The remaining product is a highly branched polyester.

### EXAMPLE 2i

The product from Example 2 i is ground in a mortar. 0.2 g of this mortar-ground product is added to 20 ml of a test microbe suspension of Pseudomonas aeruginosa. The resultant system is then shaken for a period of 4 hours. 1 mL of the test microbe suspension is then removed. After this time has expired, no remaining Pseudomonas aeruginosa microbes are detectable.

What is claimed is:

1. An antimicrobial reactive formulation comprising one or more polymerizable monomers having one or more antimicrobial polymers.

2. The antimicrobial reactive formulation as claimed in claim 1, characterized in that
the polymerizable monomers are olefinically unsaturated monomers capable of free-radical polymerization.

3. The antimicrobial reactive formulation as claimed in claim 2, characterized in that
the olefinically unsaturated monomers are vinyl derivatives, styrene compounds, allyl derivatives, olefins, compounds of acrylic or methacrylic acid, methyl methacrylate, methyl acrylate, tert-butyl methacrylate, tert-butyl acrylate, butyl methacrylate, butyl acrylate, ethyl methacrylate, ethyl acrylate, propyl methacrylate, isopropyl methacrylate, propyl methacrylate, propyl acrylate, and/or isopropyl acrylate.

4. The antimicrobial reactive formulation as claimed in claim 1, characterized in that
the polymerizable monomers are polycondensible.

5. The antimicrobial reactive formulation as claimed in claim 4, characterized in that
the polycondensible monomers are lactams, diisocyanates, diacids, and diols, or epoxides.

6. The antimicrobial reactive formulation as claimed in any of claims 1 to 5, characterized in that
the antimicrobial polymers have been prepared from at least one of the following monomers:
2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethylaminoethyl vinyl ether, and/or 3-aminopropyl vinyl ether.

7. The antimicrobial reactive formulation as claimed in any of claims 1 to 6, characterized in that
the formulation comprises from 0.01 to 25% by weight of the antimicrobial polymer.

8. The antimicrobial reactive formulation as claimed in any of claims 1 to 7, characterized in that
the formulation is obtained in the form of polymer particles with grain sizes smaller than 1 mm, in particular smaller than 500 micrometers.

9. The use of the antimicrobial reactive formulation as claimed in any of claims 1 to 8 for producing products with an antimicrobial coating.

10. The use of the antimicrobial reactive formulation as claimed in any of claims 1 to 8 in protective paints, other paints, and coatings.

11. A process for sterilizing cooling-water streams, characterized in that
the antimicrobial active formulation as claimed in any of claims 1 to 8 is added in dispersed form to the cooling water.
